(19) United States
(12) Patent Application Publication
(10) Pub. No.: US 2013/0057702 A1
(43) Pub. Date: Mar. 7, 2013

(54) OBJECT RECOGNITION AND TRACKING BASED APPARATUS AND METHOD

(71) Applicant: Sameer Chavan, Seongnam (KR)

(72) Inventor: Sameer Chavan, Seongnam (KR)

(73) Assignee: LG ELECTRONICS INC., Seoul (KR)

(21) Appl. No.: 13/698,294

(22) PCT Filed: Jul. 6, 2010
(86) PCT No.: PCT/KR2010/004401

§ 371 Date: Nov. 16, 2012

(51) Int. Cl. H04N 5/225

(52) U.S. Cl. 348/169; 348/E05.024

(57) ABSTRACT

Object recognition and tracking methods, devices and systems are disclosed. One embodiment of the present invention pertains to a method for associating an object with an event and a condition triggering the event in response to a receipt of a representation of the object to be recognized and tracked. The method also comprises tracking a movement of the object and storing information associated with the movement. The method further comprises, generating data associated with the object based on the information associated with the movement of the object in response to occurrence of the condition triggering the event.

### TECHNICAL FIELD

Embodiments of the present invention relate to the field of electronics. More particularly, embodiments of the present invention relate to an image producing device, system, and method.

### BACKGROUND ART

Home automation is an emerging practice of automating household appliances and features in residential dwellings, particularly through electronic means. The home automation may cover the automation of heating, ventilation, and air conditioning (HVAC) solutions, lighting, audio, video, security, intercoms, robotics, etc. For example, a closed-circuit television (CCTV) may be implemented in residence as a measure of crime prevention.

The home automation may be implemented directly to a house during a construction of the house. In this case, a careful planning may be needed to accommodate the available technologies. However, it may be difficult to retrofit the house with any change or upgrade to the home automation once the construction of the house is completed. Alternatively, some or all of the home automation may be implemented to the house by adding an additional system and/or device to the house. However, in this case, an extra cost may incur to purchase software and/or hardware (e.g., controllers, sensors, actuators, wires, etc.) necessary for the system and/or device.

### DISCLOSURE OF INVENTION

### Solution to Problem

One embodiment of the present invention pertains to a method of a television for object recognition and tracking. The method comprises, in response to a receipt of a representation of an object to be recognized and tracked, associating the object with an event and a condition triggering the event. The method also comprises tracking a movement of the object and storing information associated with the movement in a memory of the television. The method further comprises, in response to occurrence of the condition triggering the event, generating data associated with the object based on the information associated with the movement of the object in the memory.

Another embodiment of the present invention pertains to an apparatus for object recognition and tracking. The apparatus comprises a memory, a display module, and a controller coupled to the memory and the display module. The controller is configured to associate an object to be recognized and tracked with an event and a condition triggering the event in response to a receipt of a representation of the object to be recognized and tracked. The controller is also configured to track a movement of the object and store information associated with the movement in the memory. The controller is further configured to generate data associated with the object based on the information associated with the movement of the object in the memory in response to occurrence of the condition triggering the event.

### BRIEF DESCRIPTION OF DRAWINGS

Example embodiments are illustrated by way of example and not limitation in the figures of the accompanying drawings, in which like references indicate similar elements and in which:

FIG. 1 illustrates an exemplary view of an apparatus for object recognition and tracking, according to one embodiment of the present invention.

FIG. 2 illustrates an exemplary view of a television associating an object with an event, according to one embodiment of the present invention.

FIG. 3 illustrates an exemplary view of the television tracking an object, according to one embodiment of the present invention.

FIG. 4 illustrates an exemplary view of the television processing a search event, according to one embodiment of the present invention.

FIG. 5 illustrates an exemplary view of the television processing an alert event, according to one embodiment of the present invention.

FIG. 6 illustrates an exemplary view of the television processing another alert event, according to one embodiment of the present invention.

FIG. 7 illustrates an exemplary view of the television processing a notification event, according to one embodiment of the present invention.

FIG. 8 illustrates a process flow chart of an exemplary method for object recognition and tracking performed by the television, according to one embodiment of the present invention.

Other features of the present embodiments will be apparent from the accompanying drawings and from the detailed description that follows.

### MODE FOR THE INVENTION

A method, device and/or system are disclosed that track an object and generate data based on movement of the object. According to embodiments of this invention, one or more objects may be registered (e.g., image(s) captured and stored) with a television as object(s) to be recognized and tracked. As a part of the registration process, each of the objects may be associated with an event (e.g., a search event, an alert event, a notification event, etc.) and a condition triggering the event. Upon their registration, the objects are tracked in real time by the television which may be equipped with a camera and a controller configured to perform the function.

When the condition triggering the event is satisfied, data is generated by the television informing occurrence of the event. In one example, the location of a sought object is displayed on the screen of the television when the search event is triggered by entering the sought object using a graphical user interface of the television. In another example, the alert event is generated when the condition triggering the alert event is satisfied. For instance, when a baby approaches close to a dangerous object or place, thus meeting the condition triggering the alert event, an alert sound or visual is generated from or on the television.

In yet another example, the notification event is generated when the condition triggering the notification is satisfied. For instance, if a user and several items of the user are registered as the objects to be recognized and tracked and the user associates himself or herself with the notification event during a set time period (e.g., 8 am ? 8:30 am daily), a notification sound or visual is generated from or on the television when the user is about to head out the home without carrying all of the items associated with the user in regard to the notification event.

As described above, the television according to the embodiments provide numerous features which are needed at home but require extra systems or devices at additional cost. Thus, by providing such features using the television which can be found in almost every household, the cost for implementing systems and/or devices performing such features for home automation can be significantly reduced. Thus, embodiments include a more space efficient and cost effective solutions for home automation.

Reference will now be made in detail to the embodiments of the invention, examples of which are illustrated in the accompanying drawings. While the invention will be described in conjunction with the embodiments, it will be understood that they are not intended to limit the invention to these embodiments. On the contrary, the disclosure is intended to cover alternatives, modifications and equivalents, which may be included within the spirit and scope of the invention. Furthermore, in the detailed description, numerous specific details are set forth in order to provide a thorough understanding of the present disclosure. However, it will be obvious to one of ordinary skill in the art that the present disclosure may be practiced without these specific details. In other instances, well known methods, procedures, components, and circuits have not been described in detail as not to unnecessarily obscure aspects of the present invention.

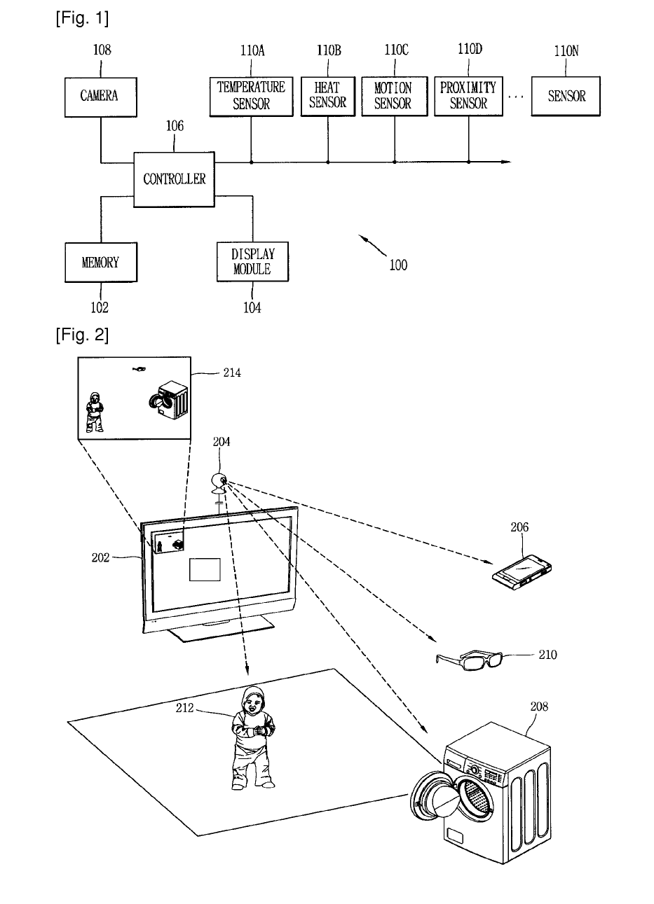

FIG. 1 illustrates an exemplary view of an apparatus 100 for object recognition and tracking, according to one embodiment of the present invention. The apparatus 100 for object recognition and tracking comprises a memory 102, a display module 104, and a controller 106 coupled to the memory 102 and the display module 104. In one embodiment, the controller 106 is configured to associate an object to be recognized and tracked with an event and a condition triggering the event in response to a receipt of a representation of the object to be recognized and tracked. In addition, the controller 106 is configured to track a movement of the object and store information associated with the movement in the memory. Further, the controller 106 is configured to generate data associated with the object based on the information associated with the movement of the object in the memory in response to occurrence of the condition triggering the event.

In FIG. 1, the apparatus 100 also comprises a camera 108 coupled to the controller 106, where the camera 108 is configured to capture the representation of the object to be recognized and tracked. The apparatus 100 further comprises one or more sensors (e.g., a temperature sensor 110A, a heat sensor 110B, a motion sensor 110C, a proximity sensor 110D, etc.) coupled to the controller 106, where the sensors are configured to generate additional information associated with the object to be recognized and tracked. In one exemplary implementation of the apparatus 100, a television (e.g., a smart television) comprises the memory 102, the display module 104, the controller 106, the camera 108, the sensors 110A-110N, and other modules to realize the object recognition and tracking features, which will be illustrated in further details from FIG. 2 through FIG. 8.

FIG. 2 illustrates an exemplary view of a television 202 associating an object with an event, according to one embodiment of the present invention. It is appreciated that the television 202 is an exemplary implementation of the apparatus 100 in FIG. 1. FIG. 2 illustrates the television 202 receiving respective images of one or more objects to be recognized and tracked. It is appreciated that object recognition (e.g., image recognition, face recognition, etc.) in computer vision is the task of finding a given object in an image or video sequence.

In one embodiment, each of the objects (e.g., a mobile phone 206, a washing machine 208, sunglasses 210, and a baby 212) is captured by the camera 204 associated with the television 202. In one exemplary implementation, the camera 204 may be implemented inside of the television 202. In another exemplary implementation, the camera 204 may be located outside of the television 202 and connected with the television 202 wirelessly or in wire. It is appreciated that the camera 204 external to the television 202 may allow the television 202 to recognize and track objects present in rooms other than where the television 202 is located. In another embodiment, an identifier of each object to be recognized and tracked is entered via a graphical user interface of the television 202. For example, the names of the mobile phone 202, the washing machine 208, the sunglasses 210, and the baby 212 may be entered using soft keyboard available on the screen of the television 202 once the menu for entering the names of the objects to be recognized and tracked is activated on the screen.

In yet another example embodiment, each object to be recognized and tracked is entered by automatically scanning a vicinity of the television 202 to search for currently available candidate objects for an object to be recognized and tracked. The scanning may be performed by the camera 204 for those objects viewable by the camera 204. The currently available candidate objects may be a subset of candidate objects, where the candidate objects are preconfigured as such. For example, the candidate objects may be a plurality of objects whose images and identifiers are already stored in the television 202 (e.g., in a database form) as possible objects to be recognized and tracked, such as a list of objects which includes a mobile phone, sunglasses, a baby, an elderly person, a wallet, a briefcase, a ring, a laptop, etc. but not a washing machine. Thus, when those objects in the room are scanned and matched with the candidate objects, then those objects in the room become the currently available candidate objects. Once the currently available candidate objects are determined as the mobile phone 206, the sunglasses 210, and the baby 212 as illustrated in FIG. 2, representations 214 of the currently available candidate objects are displayed on the screen of the television 202. Afterward, one or more objects to be recognized and tracked may be selected from the representations 214 of the currently available objects displayed on the screen of the television 202 by the user. In one example implementation, the representations 214 may be images of the currently available candidate objects in the room, and the user may select one or more of them by touching their images displayed on the screen.

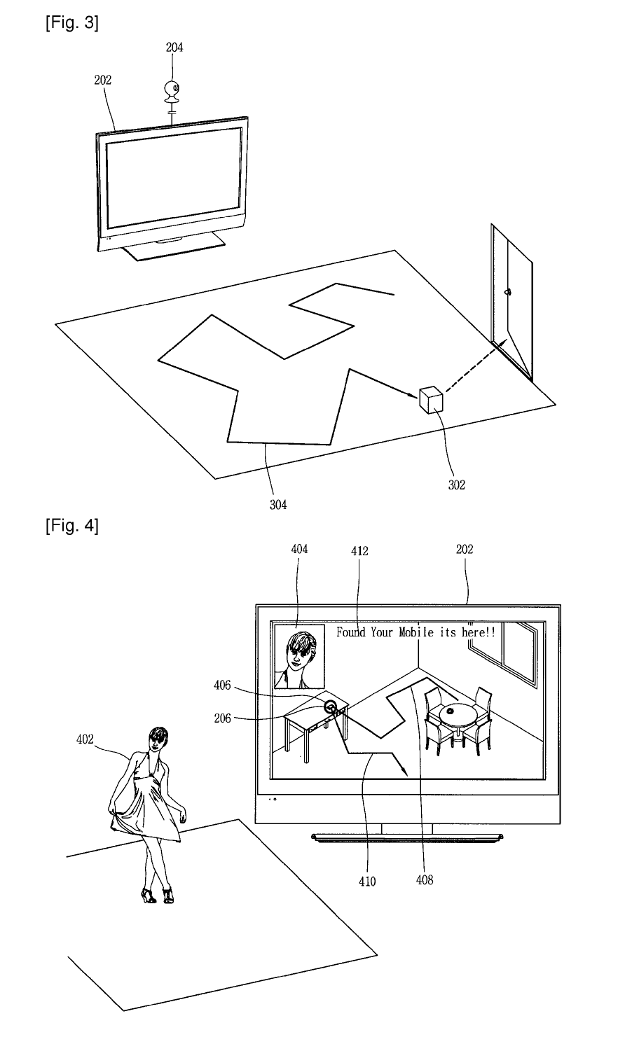

FIG. 3 illustrates an exemplary view of the television 202 tracking an object 302, according to one embodiment of the present invention. In one embodiment, a movement of the object 302 is tracked. In addition, information associated with the movement is stored in a memory (e.g., the memory 102 of FIG. 1) of the television 202. It is appreciated that object tracking refers to a method of following single or multiple objects through successive image frames in a video in real time to determine how the object(s) is moving relative to other objects.

That is, once one or more objects, such as the mobile phone 206, the sunglasses 210 and the baby 212 in FIG. 2, are registered as the objects to be recognized and tracked, tracks (e.g., a track 304 for the object 302) of the objects may be generated upon the recognition or registration of the objects as such. Accordingly, the locations of the objects may be captured, recorded, and/or stored periodically (e.g., every 10 minutes) by the television 202. Alternatively, the locations and time may be obtained only when there is a movement detected for each object.

FIG. 4 illustrates an exemplary view of the television 202 processing a search event, according to one embodiment of the present invention. Once an object to be recognized and tracked is registered with the television 202 in FIG. 2, the object may be associated with an event and a condition triggering the event. In one embodiment, the object is associated with a search event and the condition triggering the search event, where the condition triggering the search event comprises a receipt of a searching object by the television 202 and the searching object matching the object to be recognized and tracked.

For example, the mobile phone 206 may be registered as the object to be recognized and tracked in FIG. 2, and a representation (e.g., an image appearing on the television 202 or its identifier) of the mobile phone 206 may be associated with the search event. Then, the search event may occur when a user 402 of the television 202 selects from a menu of the television 202 to search for the mobile phone 206 which the user is having difficulty locating. The search event may be triggered when the user 402 keys in the name of the mobile phone 206 using the soft key displayed on the television 202 or when the user 402 utilizes a camera (e.g., the camera 204) to capture the image of the mobile phone 206. Alternatively, the user 402 may call out the name of the television 202 if the television 202 is equipped with voice recognition technology.

In one embodiment, the object to be recognized and tracked may be associated with a particular person (e.g., the user 402) such that the mobile phone 206 belonging to the user 402 among several mobile phones registered with the television 202 may be displayed on the screen of the television 202 upon recognition of the user 402 by the television 202. In addition, a user identification (ID) 404 may be displayed on the screen as well. Once the search event is triggered, data including a current location of the object is generated (e.g., determined, obtained, accessed, etc.) based on the information associated with the movement stored in the memory of the television 202. Further, data comprising the current location of the object is displayed on the screen.

In one embodiment, the current location of the object to be sought (e.g., the mobile phone 206) is presented on the screen of the television 202 as an augmented reality (AR) view 406 of the object. AR view 408 is an exemplary view of a track displaying the movement of the object up until the object is placed at the current position indicated by the AR view 406. Further, AR view 410 of the object is further used to indicate a last known location of the object or a probable location of the object (e.g., indicated by the arrow of the AR view 410) based on the information associated with the movement of the object when the current location of the object is unavailable in the memory of the television 202.

When the object (e.g., the mobile phone 206) is found (e.g., when there is a match between the searching object and one of the objects to be recognized and tracked registered with the television 202), a caption 412 (e.g., “Found your mobile. It's here!!”) may be displayed on the screen of the television 202, or an alert sound or announcement may be generated to alert the user 402 on the success of the search.

FIG. 5 illustrates an exemplary view of the television 202 processing an alert event, according to one embodiment of the present invention. Once an object to be recognized and tracked is registered with the television 202 in FIG. 2, the object may be associated with the alert event and a condition triggering the alert event. In one embodiment, for the alert event, a dangerous object associated with the object may be assigned. For example, when the object to be recognized and tracked is the baby 212, the washing machine 208 may be assigned as the dangerous object associated with the baby 212 for the alert event. In addition, the condition triggering the alert event may be preconfigured as the baby 212 approaching the washing machine 208 within a threshold distance (e.g., 1 meter).

Alternatively, a small object (e.g., a coin, a ring, a sharp object, etc.) that can be swallowed by the baby 212 may be registered and/or assigned as the dangerous object such that the alert event is triggered when the baby is close to the small object. This feature may be helpful to parents who cannot keep their eyes for the baby 212 constantly even when they are staying close to the baby 212. For instance, a mother or father may be able to tend to house chores while the baby 212 is crawling about the living room when the television 202 is capable of generating the alert event.

In response to occurrence of the condition triggering the alert event (e.g., the baby 212 approaching close to the dangerous object), data reporting the alert event may be generated. For example, a caption 504 (e.g., blinking rapidly to bring attention of the parent(s)) which reads “your baby is very close to washing machine!” may appear on the screen of the television 202 and/or a sound 506 (e.g., announcement, siren, etc.) reporting the alert event may be generated by the television 202. Further, an alert signal reporting the alert event may be forwarded to the mobile phone 206 or other communications devices to reach a responsible person away from home.

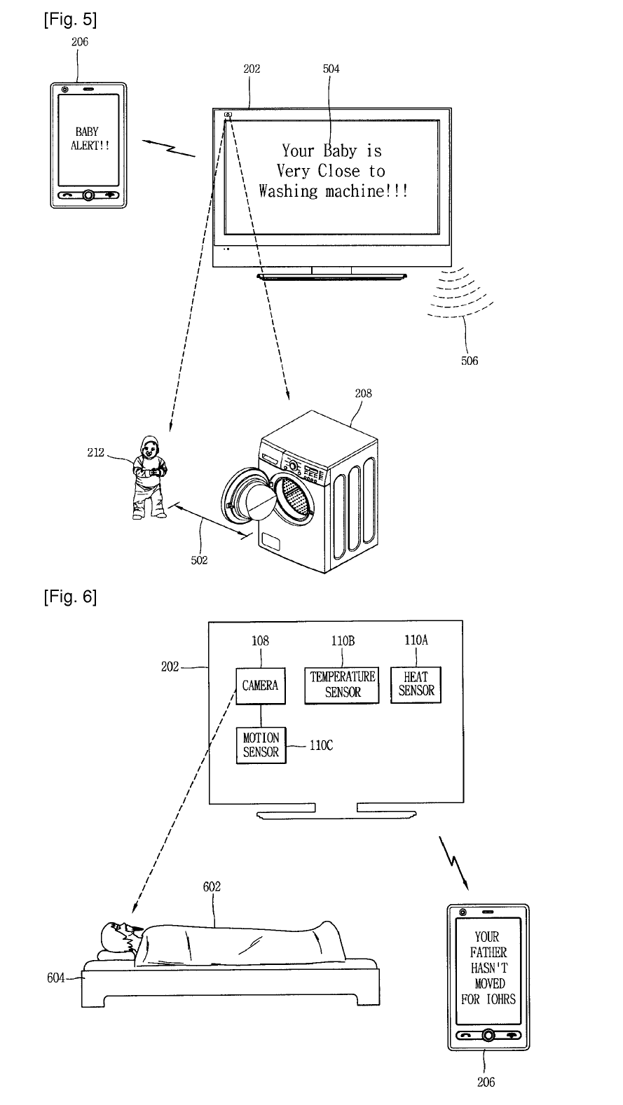

FIG. 6 illustrates an exemplary view of the television 202 processing another alert event, according to one embodiment of the present invention. Once an object to be recognized and tracked is registered with the television 202 in FIG. 2, the object may be associated with another alert event and a condition triggering the alert event. In one embodiment, an elderly person 602 (e.g., which may need some help from time to time) may be registered as the object associated with the alert event. In addition, absence of the movement by the elderly person 602 for more than a threshold time (e.g., 10 hours) may be configured as the condition triggering the alert event.

For example, the movement of the elderly person 602 may be tracked by the television 202 upon registration of the elderly person 602 as the object to be recognized and tracked associated with the alert event. The television 202 may then continuously track the movement of the elderly person 602 using the camera 108 and/or the motion sensor 110C. When the elderly person 602 lying on a bed 604 is motionless for more than 10 hours, the alert event may be triggered. In addition, the alert event may be triggered when the heat sensor 110B and/or the temperature sensor 110A senses unusual rise of the temperature within the room, where the abnormal condition may indicate that the stove or other heating apparatus is left on for a prolonged period of time. In such alert situations, an alert sound or visual may be generated to alert the elderly person 602, a neighbor, a manager of the facility where the elderly person 602 is residing, etc. Further, an alert signal reporting the alert event may be forwarded to the mobile phone 206 or other communications devices (e.g., of a caregiver, a family member, an emergency worker, etc.) registered to receive the alert signal.

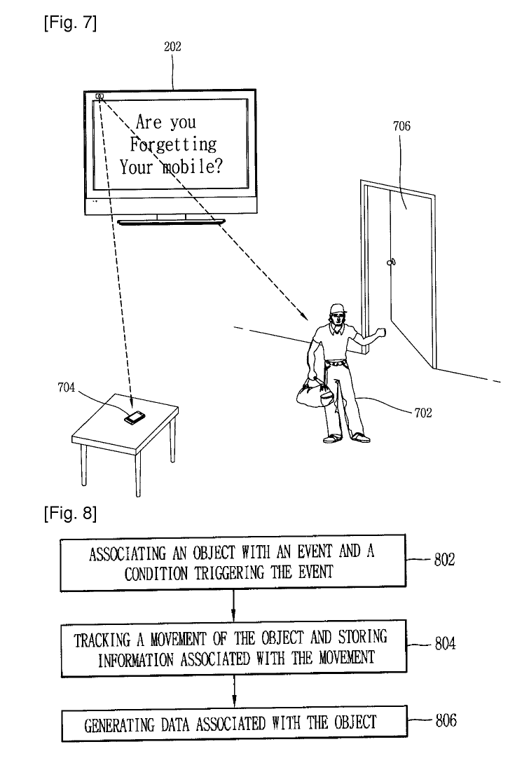

FIG. 7 illustrates an exemplary view of the television 202 processing a notification event, according to one embodiment of the present invention. Once an object to be recognized and tracked is registered with the television 202 in FIG. 2, the object may be associated with the notification event and a condition triggering the notification event. In one embodiment, a user 702 may be registered as the object associated with the notification event. In addition, in further association with the notification event, at least one item (e.g., a wallet 704) and a scheduled time period (e.g., between 8:00 am and 8:30 am) associated with the user 702 may be registered as well. Further, the condition triggering the notification event may be set for the situation of the user 702 approaching a door 706 within a threshold distance (e.g., 1 meter) during the schedule time period.

Upon the registration of the notification event, the movement of the user 702 may be tracked by the television 202 according to the schedule associated with the notification event. When the user 702 approaches the door 706 within the threshold distance during the scheduled time period to go to work, the notification event may be triggered. In such a situation, a notification sound or visual may be generated to notify the user 702 of forgetting to carry the wallet 704 to work. The television 202 may then display the location of the wallet 704 on the screen of the television 202 with a caption which reads “are you forgetting your wallet?” to notify the user 702 of the missing item.

FIG. 8 illustrates a process flow chart of an exemplary method for object recognition and tracking performed by the television 202, according to one embodiment of the present invention. In operation 802, in response to a receipt of a representation of an object to be recognized and tracked, the object is associated with an event and a condition triggering the event. In one embodiment, the receipt of the representation of the object to be recognized and tracked comprises receiving an image of the object captured by a camera associated with the television. In another embodiment, the receipt of the representation of the object to be recognized and tracked comprises receiving an identifier of the object to be recognized and tracked when the object is entered via a graphical user interface of the television.

In operation 804, a movement of the object is tracked, and information associated with the movement is stored in a memory of the television. In operation 806, in response to occurrence of the condition triggering the event, data associated with the object is generated based on the information associated with the movement of the object in the memory. In one embodiment, the data may comprise an alert signal or notification signal to report the result of the event. In another embodiment, the data may be forward to a communications device (e.g., a wired or wireless phone, PDA, computer, etc.) to alert a person registered with the event.

It is appreciated that the methods disclosed in FIG. 8 may be implemented in a form of a machine-readable medium embodying a set of instructions that, when executed by a machine, cause the machine to perform any of the operations disclosed herein.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present disclosure is not intended to be limited to the embodiments shown herein but is to be accorded the widest scope consistent with the principles and features disclosed herein.

1. A method of a television for object recognition and tracking, the method comprising:
in response to a receipt of a representation of an object to be recognized and tracked, associating the object with an event and a condition triggering the event;
tracking a movement of the object and storing information associated with the movement in a memory of the television; and
in response to occurrence of the condition triggering the event, generating data associated with the object based on the information associated with the movement of the object in the memory.

2. The method of claim 1, wherein the receipt of the representation of the object to be recognized and tracked comprises receiving an image of the object captured by a camera associated with the television.

3. The method of claim 1, wherein the receipt of the representation of the object to be recognized and tracked comprises receiving an identifier of the object to be recognized or tracked when the identifier of the object is entered via a graphical user interface of the television.

4. The method of claim 1, wherein the receipt of the representation of the object to be recognized and tracked comprises:
automatically scanning a vicinity of the television to search for currently available candidate objects for the object to be recognized and tracked, wherein the currently available candidate objects are a subset of candidate objects, and the candidate objects are preconfigured as such and the subset of candidate objects are viewable by the television;
displaying representations of the currently available candidate objects on a screen of the television; and
receiving the representation of the object to be recognized and tracked when the representation of the object is selected from the representations of the currently available candidate objects on the screen of the television.

5. The method of claim 1, wherein the event is a search event, an alert event, or a notification event.

6. The method of claim 5, wherein, when the event is the search event, the condition triggering the event comprises a receipt of a searching object by the television and the searching object matching with the object to be recognized and tracked.

7. The method of claim 6, wherein, the generating the data associated with the object comprises:
determining a current location of the object based on the information associated with the movement stored in the memory; and
displaying the current location of the object on a screen of the television.

8. The method of claim 7, wherein the displaying the current location comprises generating an augmented reality (AR) view of the object on the screen of the television.

9. The method of claim 8, wherein the displaying the current location further comprises displaying a trace of the object on the screen of the television from an initial location of the object to the current location based on the information associated with the movement of the object.

10. The method of claim 9, wherein the AR view of the object is further used to indicate a last known location of the object or a probable location of the object based on the information associated with the movement of the object when the current location of the object is unavailable in the memory of the television.

11. The method of claim 10, further comprising displaying an extended trace of the object on the screen of the television from the last known location to the probable location based on the information associated with the movement of the object.

12. The method of claim 5, wherein the associating the object with the event further comprises assigning a dangerous object associated with the object when the object to be recognized and tracked is a baby, and the condition triggering the alarm event comprises the baby approaching the dangerous object within a threshold distance.

13. The method of claim 5, wherein the object to be recognized and tracked is an elderly person, and the condition triggering the event comprises the elderly person staying still for more than a threshold time.

14. The method of claim 5, wherein the generating the data associated with the object comprises generating an alert signal in response to the condition triggering the alert event.

15. The method of claim 14, further comprising forwarding the alert signal to a mobile device communicatively coupled to the television.

16. The method of claim 6, wherein the associating the object with the event further comprises receiving an image or identifier of at least one item and a scheduled time associated with the object when the object is a person to be notified.

17. The method of claim 16, wherein the condition triggering the event comprises the person to be notified not in contact with the at least one item during the scheduled time.

18. The method of claim 17, wherein the generating the data associated with the object comprises generating a notification signal in response to the condition triggering the notification event.

19. An apparatus for object recognition and tracking, comprising:
a memory;
a controller coupled to the memory and configured to:
associate an object to be recognized and tracked with an event and a condition triggering the event in response to a receipt of a representation of the object to be recognized and tracked;
track a movement of the object and store information associated with the movement in the memory; and
generate data associated with the object based on the information associated with the movement of the object in the memory in response to occurrence of the condition triggering the event; and
a display module coupled to the controller and configured to display the data.

20. The apparatus of claim 19, further comprising a camera coupled to the controller and configured to capture the representation of the object to be recognized and tracked.

21. The apparatus of claim 19, further comprising at least one sensor coupled to the controller and configured to generate additional information associated with the object to be recognized and tracked.

22. A television object recognition and tracking, comprising:
a camera configured to capture a representation of an object to be recognized and tracked;
at least one sensor configured to sense the object;
a memory configured to store information associated with the object;
a controller coupled to the camera, the at least one sensor and the memory and the controller configured to:
associate an object to be recognized and tracked with an event and a condition triggering the event in response to a receipt of the representation of the object to be recognized and tracked from the camera;
track a movement of the object and forward the information associated with the movement of the object to the memory; and
generate data associated with the object based on the information associated with the movement of the object in response to occurrence of the condition triggering the event;and
a display module coupled to the controller and configured to display the data.
